(19) United States
(12) Patent Application Publication
(10) Pub. No.: US 2002/0080758 A1
(43) Pub. Date: Jun. 27, 2002

(54) Method of reporting radio access capacity information from a mobile station to a mobile radio network in packet mode

(75) Inventor: Bruno Landais, Viroflay (FR)

Correspondence Address: SUGHRUE MION, PLLC, Suite 800, 2100 Pennsylvania Avenue, Washington, DC, 20037-3213, US

(73) Assignee: ALCATEL

(21) Appl. No.: 10/022,418

(22) Filed: Dec. 20, 2001

(30) Foreign Application Priority Data
Dec. 21, 2000 (FR) 00 16 807

(51) Int. Cl. H04Q 7/24

(52) U.S. Cl. 370/338; 370/349

(57) ABSTRACT

A method of reporting radio access capacity information from a mobile station to a mobile radio network in packet mode, wherein:

the network determines, from mobile station identity information communicated to it, if it already holds radio access capacity information relating to the mobile station, and

if it does not already hold such information, it requests the mobile station to communicate the information to it.

The present invention relates generally to cellular mobile radio systems.

The present invention relates more particularly to packet mode services including the General Packet Radio Service (GPRS) in the case of the Global System for Mobile communications (GSM).

### BACKGROUND OF THE INVENTION

The architecture of packet mode systems such as GPRS systems, for example, is outlined in FIG. 1, and essentially includes:

base transceiver stations (BTS) in communication with mobile stations (MS) and base station controllers (BSC), the BTS and the BSC in combination being referred to as the base station subsystem (BSS), and

entities such as serving GPRS support nodes (SGSN) in communication with the BSS and with gateway GPRS support node (GSN) entities, themselves in communication with external networks (not shown).

The MS-BSS interface is referred to as the Um interface and the BSC-SGSN interface is referred to as the Gb interface.

The BSS covers functions common to circuit mode services and packet mode services and functions specific to packet mode services; the latter are supported by a particular entity of the BSS referred to as the packet control unit (PCU), which is not specifically shown in FIG. 1.

For circuit mode services, the BSS is connected to the external networks via an entity referred to as the mobile switching center (MSC). The BSC-MSC interface is referred to as the A interface. The combination of the MSC (for circuit mode services) and the SGSN and the GGSN (for packet mode services) is referred to as the core network (CN).

In the layered architecture used to describe the above systems, the Um interface between the MS and the BBS includes:

a first layer (physical layer), and

a second layer (link layer) which is itself divided into a plurality of layers: in order of increasing level, a medium access control (MAC) layer, a radio link control (RLC) layer, and a logical link control (LLC) layer.

Similarly, the Gb interface between the BSS and the SGSN includes:

a first layer (physical layer), and

a second layer (link layer) which is itself divided into a plurality of layers: in order of increasing level, a frame relay layer, a BSS GPRS protocol (BSSGP) layer, and a logical link control (LLC) layer.

Frames referred to as LLC frames are formed in the LLC layer from higher level data units. In the LLC frames, these data units are referred to as LLC-protocol data units (LLC-PDU).

The LLC-PDU are then segmented in the MAC-RLC layer to form blocks referred to as RLC data blocks. The RLC data blocks are then converted to the format required for transmission to the Um interface in the physical layer.

The RLC and LLC layers employ procedures for retransmitting data (RLC data blocks or LLC-PDU, as appropriate) that has not been received correctly, using the automatic repeat request (ARQ) technique. The correct or incorrect status of the data blocks or data units received is signaled by the receiver to the sender using acknowledgment (ACK) messages or non-acknowledgment (NACK) messages.

Signaling protocols are also provided, in particular for radio resource (RR) management, mobility management (MM), session management (SM), logical link (LL) control, etc.

Furthermore, in packet mode, a mobile station can be either:

in a packet transfer mode, in which resources are assigned temporarily, when there is actually data to be transmitted during a call, the resources forming a temporary block flow (TBF), i.e. a virtual channel enabling transfer of data between the mobile station and the network in a given transmission direction, or

in a packet idle mode, in which no TBF is set up.

On the other hand, in circuit mode, the mode in which resources are assigned to a mobile station is referred to as a dedicated mode, in which case the resources are dedicated resources assigned to the mobile station for the duration of the call.

Furthermore, it is possible to use either the one-phase access method or the two-phase access method to initialize transfer of data by a mobile station (or to set up a TBF at the initiative of the mobile station).

If a TBF is set up at the initiative of the mobile station, the latter sends the network a PACKET CHANNEL REQUEST message on an uplink packet random access channel (PRACH) or a CHANNEL REQUEST message on a common uplink random access channel (RACH).

In the case of one-phase access, the network responds with a PACKET UPLINK ASSIGNMENT message on a common downlink packet access grant channel (PAGCH) or an IMMEDIATE ASSIGNMENT message on a common downlink access grant channel (AGCH), the message indicating directly to the mobile station the resources, i.e. the packet data channels (PDCH), that have been assigned. The mobile station then uses said resources to transmit data (or RLC data blocks) in the uplink direction. Furthermore, to enable the network to identify it unambiguously, the mobile station adds to said data mobile station identity information in the form of a temporary logical link identity (TLLI). The mobile station then continues to transmit data if it receives in return from the network an acknowledgment message to which the same identity information identifying that mobile station has been added (the mobile station identity information thus being intended to enable management of the uplink or access contention in packet mode).

In the case of two-phase access, the network responds with a PACKET UPLINK ASSIGNMENT message on the PAGCH or an IMMEDIATE ASSIGNMENT message on the AGCH, that message advising the mobile station of a limited resource available on a PDCH, which it can use to transmit a PACKET RESOURCE REQUEST message containing a more precise description of the required resources and into which it also inserts mobile station identity information (for the same reasons as before).

For a more detailed description of these systems, reference may be had to the corresponding standards, for example, published by the corresponding standardization bodies, especially the document 3GPP TS 04.60 V8.6.0 (2000-10).

As a general rule, to support differing requirements in terms of services in these systems, different types of mobile station are provided, identified by corresponding information, referred to as classmark information and radio access capability information. The information is also referred to hereinafter as radio access capacity information. This information is generally known to the mobile station from the outset, and must therefore be reported to the network as and when necessary.

At present these differing requirements in terms of service correspond to characteristics such as, for example, the ability of the mobile station to transmit data simultaneously in several time slots (referred to as multislot transmission) or the ability of the mobile station to support the enhanced general packet radio service (EGPRS), which improves bit rate performance by improving the spectral efficiency of the modulation.

These differing requirements in terms of services may also correspond to the situation of a network into which there are progressively introduced, within an existing infrastructure corresponding to a system such as a second generation system (in particular the previously cited GSM), new means of radio access to that infrastructure, corresponding to a system such as a third generation system (in particular the universal mobile telecommunication system (UMTS)), with a view to progressively introducing new services, in particular high bit rate data transmission services.

The above kind of system therefore includes cells in which said new services are available, in this instance UMTS cells, and cells in which said new services are not available, in this instance GSM cells.

In a UMTS, the base station controllers (also referred to as radio network controllers (RNC)) are connected to the core network CN via an interface referred to as the lu-cs interface in the case of circuit mode services (equivalent to the GSM's A interface) or the lu-ps interface in the case of packet mode services (equivalent to the GSM's Gb interface). In a system including GSM cells and UMTS cells, at the interface level it is possible to distinguish between two modes respectively referred to as the A/Gb mode and the lu-cs/lu-ps mode.

In the cellular architecture, it is necessary to transfer calls from cell to cell as and when required. For packet mode services, a cell reselection procedure is generally used, and there are generally several ways of controlling cell reselection, corresponding to decreasing degrees of autonomy of the mobile station or increasing degrees of control by the network, which amounts to the same thing. For example, in the case of the GPRS, as specified in the standard 3GPP TS 04.60 V8.6.0 (2000-10) published by the 3GPP:

In a first control mode (NC0), the mobile station decides of its own accord to effect the above kind of transfer and itself selects the target cell to which the call is to be transferred, allowing for the results of measurements that it carries out.

In a second control mode (NC1), the mobile station can decide of its own accord to effect the above kind of transfer and select the target cell to which the call is to be transferred, taking account of the results of measurements that it carries out, and also transmits the results of these measurements to the network.

In a third control mode (NC2), the network decides to effect the above kind of transfer and selects the target cell to which the call is to be transferred, taking account of measurement results the mobile station sends it.

In a system with different types of cells, for example GSM cells and UMTS cells, it is necessary to prevent reselecting a GSM cell if the required service necessitates a UMTS cell.

If the cell reselection control mode is the NC0 mode or the NC1 mode, it is not necessary for the corresponding radio access capacity information to be communicated to the network, since cell reselection is effected autonomously by the mobile station. On the other hand, if the cell reselection control mode is the NC2 mode, it is necessary for the mobile station to communicate the corresponding radio access capacity information to the network, because cell reselection is not effected autonomously by the mobile station. The corresponding radio access capacity information then includes information such as UMTS classmark information (as defined in particular in the document 3GTS 25.331 V3.4.1 (2000-09) published by the 3GPP).

The solutions provided by the GSM standard for a mobile station to report radio access capacity information to the network in packet mode are currently as follows, for the A/Gb mode.

In a first solution, the radio access capacity information is reported by a mobile station to the BSS in the context of an uplink temporary block flow (TBF) setup procedure. This kind of solution is described in document 3GPP TS 04.60 V8.6.0 (2000-10).

A first option, corresponding to one-phase access, is for the network to request the radio access capacity information of the mobile station in the PACKET UPLINK ASSIGNMENT message following on from the reception of a (PACKET) CHANNEL REQUEST message. The mobile station then transmits that information to the network in a PACKET RESOURCE REQUEST message.

A second option, corresponding to two-phase access to the mobile station, is to use the PACKET RESOURCE REQUEST message to transmit the radio access capacity information.

In a second solution, radio access capacity information is transmitted by a mobile station to the SGSN in the context of procedures provided in the system for managing mobility, i.e. when the mobile station initially connects to the network (using the “attach” procedure) or in the event of a routing area update. According to the document 3GPP TS 08.18 V8.4.0 (2000-10), the BSS can then request from the SGSN the radio access capacity information received in this way.

The first solution has the drawback of not allowing for the fact that the BSS may already hold the radio access capacity information for a given mobile station, before requesting it (first option) or receiving it (second option) from that mobile station. Such information can also be re-requested unnecessarily, which has the drawback, on the one hand, of representing inefficient use of radio resources and, on the other hand, of unnecessarily introducing a time-delay before transfer of data can begin (in other words, of unnecessarily degrading the quality of service).

One particular drawback of the second solution is that it introduces supplementary exchanges of data between the SGSN and the BSS (because the entity using such information is the BSS and not the SGSN), and moreover imposes such exchanges unnecessarily in the case of a dual mode (packet mode/circuit mode) mobile station.

### OBJECTS AND SUMMARY OF THE INVENTION

A particular object of the present invention is to propose a new procedure for reporting radio access capacity information from a mobile station to a mobile radio communication network in packet mode, which procedure is intended in particular to avoid the various drawbacks previously cited. The present invention can be applied in particular to packet mode mobile stations operating in the A/Gb mode and to radio access capacity information including UMTS classmark information.

Thus the present invention provides a method of reporting radio access capacity information from a mobile station to a mobile radio network in packet mode, wherein:

the network determines, from mobile station identity information communicated to it, if it already holds radio access capacity information relating to the mobile station, and

if it does not already hold such information, it requests the mobile station to communicate the information to it.

According to another feature, said mobile station identity information is information for managing the uplink in packet mode.

According to another feature, said mobile station identity information is transmitted with data transmitted in the uplink direction.

According to another feature, the network requests the mobile station to communicate said radio access capacity information to it in a message acknowledging data received in the uplink direction.

According to another feature, said system is a GPRS system and said message is a PACKET UPLINK ACK/NACK message.

According to another feature, said mobile station identity information is transmitted with an uplink data transmission resource assignment request.

According to another feature, the network requests the mobile station to communicate said radio access capacity information to it in an uplink radio resource assignment message.

According to another feature, said system is a GPRS system and said message a PACKET UPLINK ASSIGNMENT message.

According to another feature, said mobile station identity information has already been communicated to the network in the context of a downlink transfer of data already set up.

According to another feature, the network requests the mobile station to communicate said radio access capacity information to it in an uplink radio resource assignment message.

The invention also provides a packet mode mobile radio network entity which includes, for implementing the above method:

means for determining, from mobile station identity information that is communicated to it, if it already holds radio access capacity information relating to the mobile station, and

means for requesting the mobile station to communicate said information to it if it does not already hold the information.

According to another feature, said network is a GPRS network and said entity is a packet control unit (PCU).

The invention also provides a mobile station which includes, for implementing the above method:

means for receiving a request to communicate radio access capacity information, and

means for transmitting such information to the network in response to said request.

### BRIEF DESCRIPTION OF THE DRAWINGS

Other objects and features of the present invention will become apparent on reading the following description of embodiments of the invention, which description is given with reference to the accompanying drawings, in which:

FIG. 1, previously described, is a diagram outlining the general architecture of a GPRS cellular mobile radio system,

FIG. 2 is a diagram showing a first embodiment of a method according to the invention,

FIG. 3 is a diagram showing a second embodiment of a method according to the invention, and

FIG. 4 is a diagram showing a third embodiment of a method according to the invention.

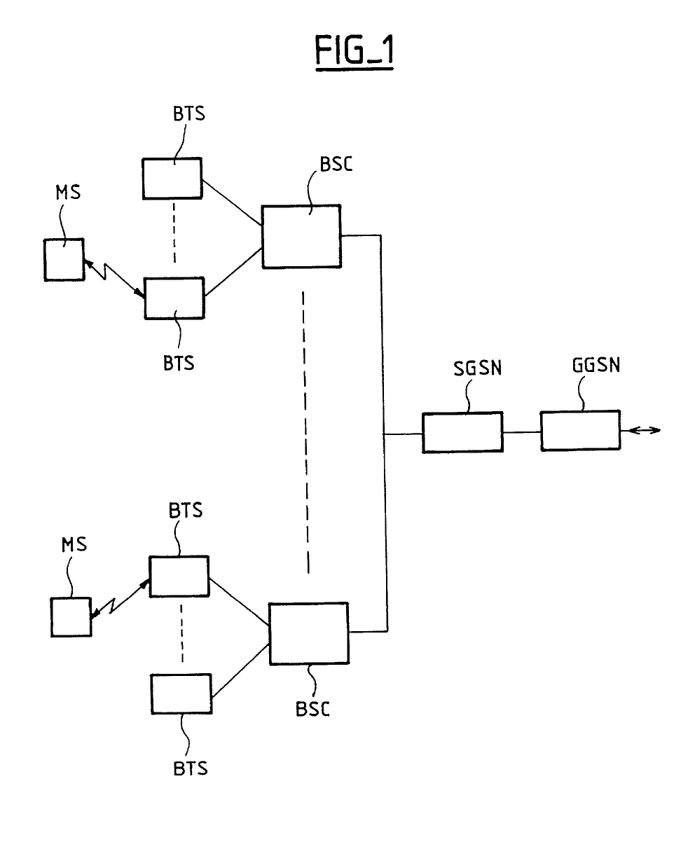

### MORE DETAILED DESCRIPTION

Thus the present invention provides a method of reporting radio access capacity information from a mobile station to a mobile radio network in packet mode.

Essentially, in accordance with the invention:

the network determines, from mobile station identity information communicated to it, if it already holds radio access capacity information relating to the mobile station, and

if it does not already hold such information, it requests the mobile station to communicate the information to it.

The present invention is more particularly described hereinafter in connection with a GPRS system, for example.

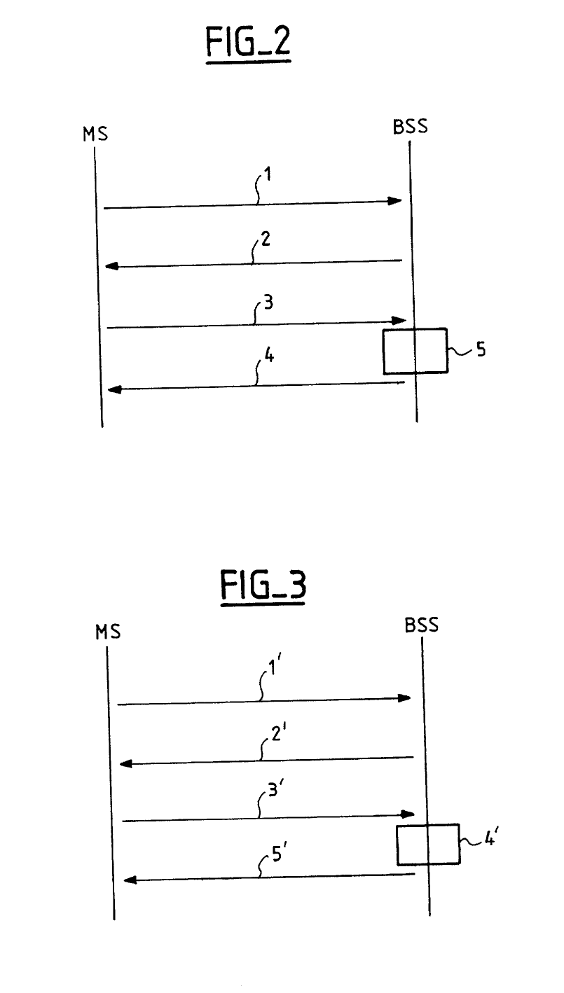

In a first embodiment, shown in FIG. 2, the invention is used when setting up an uplink temporary block flow (TBF) at the initiative of the mobile station and using the one-phase access procedure.

In this case the mobile station sends the network a PACKET CHANNEL REQUEST message, as noted at 1, on a common uplink channel (PRACH). The network then responds with a PACKET UPLINK ASSIGNMENT message, as noted at 2, on a common downlink channel (PAGCH), the latter message indicating directly to the mobile station the resources (PDCH) it has been assigned. The mobile station then uses those resources to transmit data (or RLC data blocks), as noted at 3, in the uplink direction. Furthermore, to enable the network to identify it unambiguously, as previously mentioned, the mobile station adds to these data blocks mobile station identity information (TLLI). In this instance the TLLI is added to the header part of the RLC data blocks. In return, the network transmits acknowledgment or PACKET UPLINK ACK/NACK messages, as noted at 4, to which the same identity information is added to identify the mobile station.

In accordance with the invention, on receiving an RLC data block (especially the first one), and as noted at 5, the network determines from the mobile station identity information communicated to it in this way if it already holds radio access capacity information relating to the mobile station concerned.

If it does not already hold that information, it requests the mobile station to communicate the information to it. The network advantageously sends this request to the mobile station in a PACKET UPLINK ACK/NACK message acknowledging data received in the uplink direction, as noted at 4, in which case a particular field of that message is used to that effect.

In a second embodiment, shown in FIG. 3, the invention is used at the time of setting up an uplink temporary block flow (TBF) at the initiative of the mobile station and using the two-phase access procedure.

In this case the mobile station sends the network a PACKET CHANNEL REQUEST message, as noted at 1′, on a common uplink channel (PRACH). The network then responds with a PACKET UPLINK ASSIGNMENT message, as noted at 2′, on a common downlink channel (PAGCH), that message allocating an uplink RLC data block. The mobile station uses that block to transmit an uplink resource allocation request message PACKET RESOURCE REQUEST including the identity of the mobile station, as noted at 3′.

In accordance with the invention, on receiving said block, and as noted at 4′, the network determines from the mobile station identity information communicated to it in this way if it already holds radio access capacity information relating to the mobile station concerned.

If it does not hold such information already, it requests the mobile station to communicate the information to it. The network advantageously sends this request to the mobile station in an uplink resource allocation message PACKET UPLINK ASSIGNMENT transmitted to the mobile station at this time, as noted at 5′, in which case a particular field of that message is used to that effect.

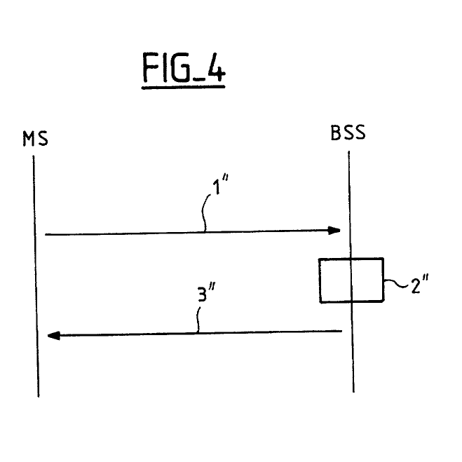

In a third embodiment, shown in FIG. 4, the invention is implemented at the time of setting up an uplink temporary block flow (TBF) at the initiative of the mobile station when a downlink TBF has already been set up.

In this case, as noted at 1″, the mobile station transmits a request to set up an uplink TBF in a PACKET DOWNLINK ACK/NACK message acknowledging data received in the downlink direction.

In accordance with the invention, and as noted at 2″, on receiving said message, the network determines, from mobile station identity information that has been communicated to it already in the context of the transfer of data already set up for the downlink direction, if it already holds radio access capacity information relating to the mobile station concerned.

If it does not hold such information already, it requests the mobile station to communicate the information to it. The network advantageously sends this request to the mobile station in an uplink resource allocation message PACKET UPLINK ASSIGNMENT transmitted to the mobile station at this time, as noted at 3″, in which case a particular field of that message is used to that effect.

Note that FIGS. 2 to 4 show such processes only diagrammatically, to the degree needed to understand the present invention, and without going into the signaling methods or protocols in more detail, as they can be based on principles that are conventional in such systems.

Note further that in the examples described the request transmitted by the network to the mobile station and requesting the latter to communicate said radio access capacity information to the network is transmitted by means of in-band signaling, i.e. using existing messages, to which a new field is added. In the examples described, the existing messages are the PACKET UPLINK ACK/NACK and PACKET UPLINK ASSIGNMENT messages. Other examples of existing messages that could be used are the PACKET DOWNLINK ASSIGNMENT message, the PACKET TIMESLOT RECONFIGURE message, etc. These in-band signaling messages can therefore be used when an uplink or downlink TBF has already been set up (i.e. when the mobile station is in the packet transfer mode) or is in the process of being set up.

In another example, the request transmitted by the network to the mobile station and requesting the latter to communicate said radio access capacity information to it can be transmitted using out-band signaling, i.e. by creating a new message specifically for this purpose, which message might be referred to as a CLASSMARK INQUIRY message. This example of out-band signaling can be used with the mobile station either in the packet idle mode or in the packet transfer mode.

The response of the mobile station to this kind of request can be transmitted in a new message, created specifically for this purpose, and that might be referred to as a CLASSMARK CHANGE message. If the mobile station is in the packet transfer mode it can use a block on the PACCH to transmit the information. If the mobile station is in the packet transfer mode it can use existing procedures to request the assignment of a block for transmitting the information in the uplink direction. If necessary, if said information is too long, and if one block is insufficient, it could repeat the assignment request. Alternatively, a plurality of PACCH blocks could be assigned to the mobile station to enable it to uplink all of the requested information.

Note that, generally speaking, the network may already hold said radio access capacity information because that information has already been reported to it, in particular when setting up an uplink or downlink TBF.

Note also that, generally speaking, the network may hold said mobile station identity information, in particular because this information has already been communicated to it or is communicated to it at the time of setting up an uplink or downlink TBF.

In addition to the above method, the present invention provides a cellular mobile radio network entity and a mobile station including means for implementing the method.

Thus a packet mode cellular mobile radio network entity for implementing a method according to the invention essentially includes:

means for determining, from mobile station identity information that is communicated to it, if it already holds radio access capacity information relating to the mobile station, and

means for requesting the mobile station to communicate said information to it if it does not already hold the information.

For example, in a GPRS system, said entity is the packet control unit (PCU).

Similarly, a mobile station for implementing a method according to the invention essentially includes:

means for receiving a request to communicate radio access capacity information, and

means for transmitting such information to the network in response to said request.

The specific implementation of such means representing no particular problem to the person skilled in the art, such means do not need to be described here in more detail than, as previously, by stating their function.

1. A method of reporting radio access capacity information from a mobile station to a mobile radio network in packet mode, wherein:
the network determines, from mobile station identity information communicated to it, if it already holds radio access capacity information relating to the mobile station, and
if it does not already hold such information, it requests the mobile station to communicate the information to it.

2. A method according to claim 1, wherein said mobile station identity information is information for managing the uplink in packet mode.

3. A method according to claim 2, wherein said mobile station identity information is transmitted with data transmitted in the uplink direction.

4. A method according to claim 3, wherein the network requests the mobile station to communicate said radio access capacity information to it in a message acknowledging data received in the uplink direction.

5. A method according to claim 4, wherein said system is a GPRS system and said message is a PACKET UPLINK ACK/NACK message.

6. A method according to claim 1, wherein said mobile station identity information is transmitted with an uplink data transmission resource assignment request.

7. A method according to claim 6, wherein the network requests the mobile station to communicate said radio access capacity information to it in an uplink radio resource assignment message.

8. A method according to claim 7, wherein said system is a GPRS system and said message is a PACKET UPLINK ASSIGNMENT message.

9. A method according to claim 1, wherein said mobile station identity information has already been communicated to the network in the context of a downlink transfer of data already set up.

10. A method according to claim 9, wherein the network requests the mobile station to communicate said radio access capacity information to it in an uplink radio resource assignment message.

11. A packet mode mobile radio network entity including, for implementing a method according to claim 1:
means for determining, from mobile station identity information that is communicated to it, if it already holds radio access capacity information relating to the mobile station, and
means for requesting the mobile station to communicate said information to it if it does not already hold the information.

12. An entity according to claim 11, wherein said network is a GPRS network and said entity is a packet control unit (PCU).

13. A mobile station including, for implementing a method according to claim 1:
means for receiving a request to communicate radio access capacity information, and
means for transmitting such information to the network in response to said request.
